(19) United States
(12) Patent Application Publication
(10) Pub. No.: US 2024/0210181 A1
(43) Pub. Date: Jun. 27, 2024

(54) APPARATUS AND METHOD FOR COMPLETING ENTITY ACTIONS USING A COMPUTING DEVICE

(71) Applicant: TruckWise, LLC, Estill, SC (US)

(72) Inventor: Wise Henry Batten, JR., Bluffton, SC (US)

(73) Assignee: TruckWise, LLC, Estill, SC (US)

(21) Appl. No.: 18/087,316

(22) Filed: Dec. 22, 2022

(51) Int. Cl. G01C 21/34; G07C 5/02

(52) U.S. Cl. CPC G01C 21/343; G07C 5/02

(57) ABSTRACT

An apparatus and method for completing entity action using a computing device, wherein the apparatus includes at least a processor and a memory communicatively connected to the at least a processor containing instructions configuring the at least a processor to receive a first entity profile from a first entity, generate an entity action as a function of the first entity profile, wherein the entity action includes a plurality of entity action parameters, receive at least one second entity profile associate with the entity action from a plurality of second entities, identify at least one second entity as a function of the at least one second entity profile and the entity action, and generate a completion datum as a function of the entity action and the at least one second entity.

### FIELD OF THE INVENTION

The present invention generally relates to the field of digital solution of recruiting a vehicle driver. In particular, the present invention is directed to an apparatus and method for completing entity action using a computing device.

### BACKGROUND

Many industries today regularly need long distance and large weight movers for transportation of products from one location to another. In a non-limiting example, in the logging industry, trucks are needed for transportation of trees from the woods to various timber products mills. Likewise, in a non-limiting example, in the pine straw industry, trucks are used for the transportation of pine needles from the woods to an end user or to a business that sells pine straw bales. An easy-to-use solution that efficiently matches vehicle driver and suppliers is necessary. Existing solutions are not satisfactory.

### SUMMARY OF THE DISCLOSURE

In an aspect, an apparatus for completing entity action using a computing device, wherein the apparatus includes at least a processor and a memory communicatively connected to the at least a processor containing instructions configuring the at least a processor to receive a first entity profile from a first entity, generate an entity action as a function of the first entity profile, wherein the entity action includes a plurality of entity action parameters, receive at least one second entity profile associate with the entity action from a plurality of second entities, identify at least one second entity as a function of the at least one second entity profile and the entity action, and generate a completion datum as a function of the entity action and the at least one second entity.

In another aspect, a method for completing entity action using a computing device, the method includes receiving, by at least a processor, a first entity profile from a first entity, generating, by the at least a processor, an entity action as a function of the first entity profile, wherein the entity action includes a plurality of entity action parameters, receiving, by the at least a processor, at least one second entity profile associate with the entity action from a plurality of second entities, identifying, by the at least a processor, at least one second entity as a function of the at least one second entity profile and the entity action, and generating, by the at least a processor, a completion datum as a function of the entity action and the at least one second entity.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for completing entity action using a computing device;

FIG. 2 is a block diagram of an exemplary embodiment of a machine-learning module;

FIG. 3 is a block diagram illustrating an exemplary embodiment of a neural network;

FIG. 4 is a block diagram illustrating an exemplary embodiment of a node in a neural network;

FIG. 5 is a schematic diagram illustrating an exemplary embodiment of a fuzzy inferencing system;

FIG. 6 is a flow diagram of an exemplary embodiment of a method for recruiting a vehicle driver using a computing device; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatus and methods for completing entity action using a computing device. In an embodiment, apparatus and methods includes inputting an entity action as a function of a first entity profile, wherein the first entity profile contains a plurality of first entity related data.

Aspects of the present disclosure can be used to hire a second entity such as, without limitation, a vehicle driver. Aspects of the present disclosure can also be used to hire a second entity in various industries such as, without limitation, agriculture, logging, forest products mills, dirt/grading/paving contractors/mining operations, heavy equipment transport, port industry, pine straw, nurseries, oil and natural gas, hazardous materials, and the like thereof. This is so, at least in part, because apparatus and methods include identifying at least one second entity as a function of the at least one second entity profile and the entity action. In some embodiments, identifying at least one second entity may include identifying at least one second entity using a machine-learning process.

Aspects of the present disclosure allow for tracking the location of vehicle, store electronic tickets, electronic bills of lading, and/or delivery orders. In some embodiments, first entity may offer action execution datum to vehicle driver after the entity action has been completed. Exemplary embodiments illustrating aspects of the present disclosure are described below in the context of several specific examples.

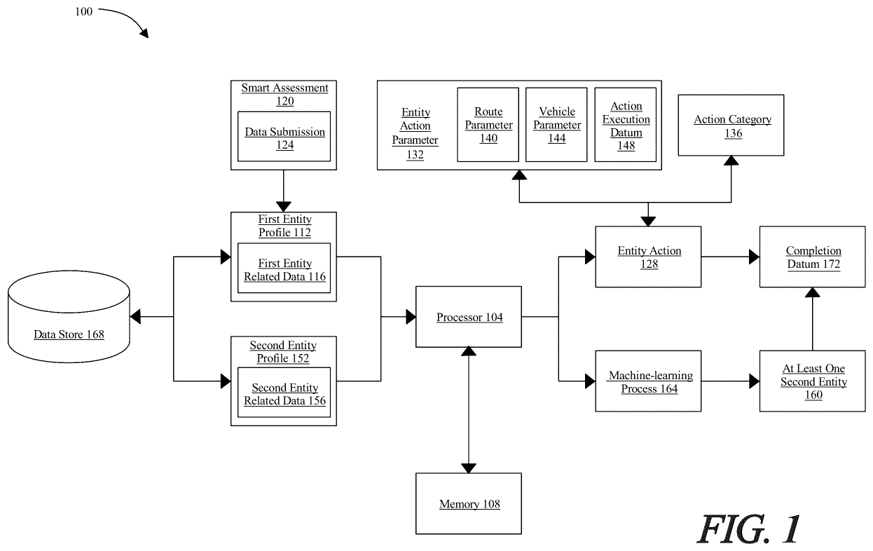

Referring now to FIG. 1, an exemplary embodiment of an apparatus for completing entity action using a computing device is illustrated. Apparatus includes a processor 104 and a memory 108 communicatively connected to the processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, as used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 is configured to receive a first entity profile 112 from a first entity. As used in this disclosure, “receive” means to accept, collect, or otherwise receive input from first entity and/or a device. As used in this disclosure, a “first entity” is an individual or a group of individuals who demonstrate a need for a vehicle for accomplishing tasks. In some embodiments, first entity may include, without limitation, individual, family, small business, company, enterprise, or the like thereof. In a non-limiting example, first entity may include a company in logging industry that needs a plurality of trucks for transportation of trees. As used in this disclosure, a “first entity profile” is a collection of data and/or information including a plurality of first entity related data. For the purposes of this disclosure, “first entity related data” is information related to first entity. In an embodiment, first entity profile 112 and/or first entity related data may be obtained using a user device associated with a user. A “user device,” for the purpose of this disclosure, is any additional computing device, such as a mobile device, laptop, desktop computer, or the like. In a non-limiting embodiment, user device may be a computer and/or smart phone operated by a user in a remote location. User device may include, without limitation, a display; the display may include any display as described in the entirety of this disclosure such as a light emitting diode (LED) screen, liquid crystal display (LCD), organic LED, cathode ray tube (CRT), touch screen, or any combination thereof. In a non-limiting embodiment, user device may include a visual interface configured to display any information from apparatus 100 and/or computing device.

With continued reference to FIG. 1, in an exemplary embodiment and without limitation, first entity related data 116 may include any personal information related to the first entity. In some cases, personal information may include, without limitation, first entity's name, age, gender, identification, geographical information, and the like thereof. In some embodiments, without limitation, first entity related data 116 may include health information related to first entity. In some cases, health information may include, without limitation, first entity's personal wellness, insurance, business health such as, without limitation, liquidity, solvency, profitability, operating efficiency, and the like thereof. In other embodiments, first entity related data 116 may include professional information related to the first entity. In some cases, professional information may include, without limitation, job poster's profession, experience in profession, company information, employer/employee information, business radius, and the like thereof. Additionally, or alternatively, first entity related data may be in various format described below. In some embodiments, first entity related data may be present in any data structure described below in this disclosure. In a non-limiting example, processor 104 may receive a first entity profile 112 in a text file format, wherein the first entity profile 112 may include first entity's personal information such as, without limitation, user's name, age, gender, home address, and the like thereof.

With continued reference to FIG. 1, in some embodiments, first entity profile 112 and/or any data/information described in this disclosure may be present as a vector. As used in this disclosure, a “vector” is a data structure that represents one or more quantitative values and/or measures of home resource data. A vector may be represented as an n-tuple of values, where n is one or more values, as described in further detail below; a vector may alternatively or additionally be represented as an element of a vector space, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent, for instance as measured using cosine similarity as computed using a dot product of two vectors; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes.

With continued reference to FIG. 1, in some embodiments, first entity profile 112 and/or any other data/information described in this disclosure may be present as a dictionary. As used in this disclosure, a “dictionary” is a data structure containing an unordered set of key value pairs. In this disclosure, a “key value pair” is a data representation of a data element such as, without limitation, entries of first entity related data, any other information within first entity profile 112, and the like thereof. In some cases, dictionary may be an associative memory, or associative arrays, or the like thereof. In a non-limiting example, dictionary may be a hash table. In an embodiment, kay value pair may include a unique key, wherein the unique kay may associate with one or more values. In another embodiment, key value pair may include a value, wherein the value may associate with a single key. In some cases, each key value pair of set of key value pairs in dictionary may be separated by a separator, wherein the separator is an element for separating two key value pairs. In a non-limiting example, separator may be a comma in between each key value pairs of plurality of key value pairs within dictionary. In another non-limiting example, a dictionary may be expressed as “{first key value pair, second key value pair},” wherein the first key value pair and the second key value pair may be separate by a comma separator, and wherein both first key value pair and second key value pair may be expressed as “first/second key: first/second value.” In a further non-limiting example, first entity profile 112 may be present as a dictionary: “{x: A, y: B},” wherein x may be a first entry correspond to a first entity related data A and y may be a second entry correspond to a different first entity related data B. Additionally, or alternatively, dictionary may include a term index, wherein the term index is a data structure to facilitate fast lookup of entries within dictionary (i.e., index). In some cases, without limitation, term index may use a zero-based indexing, wherein the zero-based indexing may configure dictionary to start with index 0. In some cases, without limitation, term index may use a one-based indexing, wherein the one-based indexing may configure dictionary to start with index 1. In other cases, without limitation, term index may use a n-based indexing, wherein the n-based indexing may configure dictionary to start with any index from 0 to n. Further, term index may be determined/calculated using one or more hash functions. As used in this disclosure, a “hash function” is a function used to map a data of arbitrary size to a fixed-size value. In some cases, a fixed-size value may include, but is not limited to, hash value, hash code, hash digest, and the like. In a non-limiting example, first entity profile 112 may be present as a dictionary containing a plurality of hashes generated using hash function such as, without limitation, identity hash function, trivial hash function, division hash function, word length folding, and the like, wherein each hash of plurality of hashes may represents a single entry of first entity related data within first entity profile 112.

With continued reference to FIG. 1, in other embodiments, first entity profile 112 and/or any other data/information described in this disclosure may be present as any other data structure such as, without limitation, tuple, single dimension array, multi-dimension array, list, linked list, queue, set, stack, dequeue, stream, map, graph, tree, and the like thereof. In some embodiments, first entity profile 112 and/or any other data/information described in this disclosure may be present as a combination of more than one above data structures. In a non-limiting example, first entity profile 112 may include a dictionary of lists. As will be appreciated by persons having ordinary skill in the art, after having read the entirety of this disclosure, the foregoing list is provided by way of example and other data structures can be added as an extension or improvements of apparatus 100 disclosed herein. In some embodiments, without limitation, data structure may include an immutable data structure, wherein the immutable data structure is a data structure that cannot be changed, modified, and/or updated once data structure is initialized. In other embodiments, without limitation, data structure may include a mutable data structure, wherein the mutable data structure is a data collection that can be changed, modified, and/or updated once data structure is initialized. Additionally, or alternatively, first entity profile 112 and/or any other data/information described in this disclosure may include an electric file format such as, without limitation, txt file, JSON file, XML file, word document, pdf file, excel sheet, image, video, audio, and the like thereof.

With continued reference to FIG. 1, in some cases, data within data structure described above may be sorted in a certain order such as, without limitation, ascending order, descending order, and the like thereof. In a non-limiting example, sorting data within first entity profile 112 may include using a sorting algorithm. In some cases, sorting algorithm may include, but is not limited to, selection sort, bubble sort, insertion sort, merge sort, quick sort, heap sort, radix sort, and the like thereof. In a non-limiting example, user related data within first entity profile 112 may be sorted in an alphabetical order. As will be appreciated by persons having ordinary skill in the art, after having read the entirety of this disclosure, the foregoing list is provided by way of example and other sorting algorithm can be added as an extension or improvements of apparatus 100 disclosed herein.

With continued reference to FIG. 1, in some embodiments, receiving first entity profile 112 may include accepting a smart assessment 120 containing a data submission 124 from the first entity. As used in this disclosure, a “smart assessment” is a set of questions that asks for first entity related information. In some embodiments, each question within the set of questions of smart assessment 120 may include at least one answer and/or non-answer (such as leaving the question blank). In some cases, a question within smart assessment 120 may include selecting a selection from plurality of selections as answer. In other cases, question within smart assessment 120 may include a free user input as answer. As used in this disclosure, a “free user input” is an input that is not defined, or otherwise constrained by existing answers to its corresponding question. In a non-limiting example, answer to a question within smart assessment 120 may include text input in addition to existing choice selections. In some embodiments, smart assessment 120 may include questions in a plurality of categories such as, without limitation, personal information, health information, professional information, and the like thereof; for instance, without limitation, one of plurality of question may include asking first entity's first name and/or last name, while another one of plurality of question may include asking first entity's industry and/or company name. In some embodiments, smart assessment 120 may be in a form such as, without limitation, survey, interview, report, events monitoring, and the like thereof. As used in this disclosure, a “data submission” is an assemblage of data provided by an entity as an input source. In some embodiments, data submission 124 may include one or more documentations collected from the job poster. In a non-limiting example, data submission 124 may include job poster uploads one or more first entity profiles to processor 104. As used in this disclosure, a “documentation” is a source of information. In some cases, documentation may include electronic document, such as, without limitation, txt file, JSON file, word document, pdf file, excel sheet, image, video, audio, and the like thereof. In a non-limiting example, documentation may include identification documents, company registration, insurance documents, any documents related to first entity related data 116, and the like may be input source of data submission 124 for further processing. Further processing may include any processing step described below in this disclosure.

With continued reference to FIG. 1, processor is configured to generate a entity action 128 as a function of first entity profile 112, wherein the entity action 128 contains a plurality of entity action parameters 132. As used in this disclosure, a “entity action” is a paid task or piece of work of the first entity. In a non-limiting example, entity action 128 may include one or more works that the first entity expects to complete. In some embodiments, entity action 128 may be generated through smart assessment 120 described above. In a non-limiting example, smart assessment 120 may include one or more questions asking entity action related information, such as, without limitation, entity action parameters 132 and the like thereof. In some embodiments, generating entity action 128 may include selecting an action category 136. As used in this disclosure, a “action category” is a category of entity action 128. In some embodiments, action category 136 may include a public entity action. As used in this disclosure, a “public entity action” refers to publicly advertised entity action 128. Public entity action may be visible and/or available to all users such as, without limitation, first entity, vehicle drivers, any other users, and/or the like thereof. In a non-limiting example, first entity may post a public entity action, wherein the public entity action may be posted on a public entity action board for all vehicle drivers to see which first entity operate in a given service area and with the specific vehicle requirement specified by the first entity when generating entity action 128 posting; for instance, without limitation, logging trucking companies who work in Georgia may never see logging job (i.e., entity action) posted by a first entity in California. Likewise, logging trucking companies may never be shown public entity actions regarding dirt hauling jobs posted by the first entity. Additionally, public entity action may be shared between users, devices, and/or third-party platforms; for instance, without limitation, processor 104 may generate a entity action 128 and share the entity action 128 on one or more social media platforms. In some embodiments, action category 136 may include a private entity action. As used in this disclosure, a “private entity action” is entity action 128 which is advertised only to a specific group of first entities, vehicle drivers, and or users using apparatus 100. In some cases, private entity action may be advertised only to trusted contracts; for instance, without limitation, private entity action may only be shared with vehicle drivers in contacts of first entity that first entity normally does business with. In a non-limiting example, first entity may decide who to share the entity action with; for instance, a first entity who only works with 10 approved trucking companies may generate a private entity action using processor 104 with those 10 companies at once. Additionally, or alternatively, action category 136 may include a dispatch entity action. As used in this disclosure, a “dispatch entity action” is entity action 128 that is assigned to a pre-selected vehicle driver and/or company. In some embodiments, vehicle driver and/or company may be automatically selected by processor 104 as described in further detail below. Further, generating entity action 128 may include generating a job code using processor 104. As used in this disclosure, a “entity action code” is a unique identifier of entity action 128. In a non-limiting example, entity action code may be a universally unique identifier (UUID) generated by processor 104 concatenating 48-bit MAC address, 60-bit timestamp, 5-7 bits of variant, 1-3 bits of UUID version, and 13-14 bits of clock sequence. First entity, vehicle drivers, and/or users of apparatus may be able to locate entity action 128 using entity action code on entity action board if, and only if entity action 128 is public entity action or dispatch entity action.

With continued reference to FIG. 1, as used in this disclosure, a “entity action parameter” is an requirement for an entity action 128. In some embodiments, entity action parameters 132 may include one or more first entity related data 116 from first entity profile. In a non-limiting example, generating entity action 128 through smart assessment 120 may include extracting one or more answers (i.e., first entity related data 116) to one or more questions within smart assessment 120; for instance, first entity's company name, industry, geographical information, and the like thereof. In another non-limiting example, entity action 128 may include one or more first entity related data 116 such as, without limitation, company location, first entity's contact and the like collected through directly access to first entity profile 112 of the first entity as entity action parameters 132; for instance, entity action parameters 132 may include a link, such as, without limitation, a uniform resource locator (URL) to first entity profile 112 of the first entity. In a non-limiting example, processor 104 may be configured to extract one or more answers to one or more questions within smart assessment 120 using a language processing module. Language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

Still referring to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

Still referring to FIG. 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between an extracted words, phrases, and/or other semantic units. There may be a finite number of categories to which an extracted word may pertain; an HMM inference algorithm, such as the forward-back ward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

Continuing to refer to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

Still referring to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or processor 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into processor 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York.

With continued reference to FIG. 1, in some embodiments, plurality of entity action parameters 132 may include a plurality of route parameters 140. As used in this disclosure, a “route parameter” is entity action parameter 132 related to geographic information of entity action 128. In a non-limiting example, route parameters 140 within entity action parameters 132 may include identification of one or more geographic information such as, without limitation, route of transportation for entity action 128. In some embodiments, route parameters 140 may include at least one route origin and at least one route destination. “Route origin,” as described herein, is a geographic location that is the beginning of the route of transportation for entity action 128, while “route destination,” as described herein, is a geographic location that is the end of the route of transportation for entity action 128. In some cases, route parameters 140 may include a plurality of route destinations; for instance, destination, backhaul origin, backhaul destination, and the like, thereof. In a non-limiting example, route parameters 140 within entity action parameters 132 may be expressed in alphanumeric characters; for instance, route parameters 140 may include a first GPS coordinate and a second GPS coordinate, wherein the first GPS coordinate is route origin, and the second GPS coordinate is route destination. In some cases, route parameters 140 may further include, without limitation, route length, route details, route instructions, route navigations, and the like thereof. In some embodiments, plurality of entity action parameters 132 may include a plurality of vehicle parameters 144. As used in this disclosure, a “vehicle parameter” is entity action parameter 132 related to vehicle information of one or more vehicles for entity action 128. In some cases, vehicle parameters 144 may include vehicle information of one or more required vehicles; for instance, without limitation, logging truck may be required for entity action 128 posted by logging companies in logging industry. In other cases, vehicle parameters 144 may include vehicle information of one or more suggested vehicles; for instance, without limitation, pickup trucks, cargo vans, and box trucks may all be used for moving. In a non-limiting example, vehicle parameters 144 may include number of vehicles needed, vehicle types, vehicle payload volume, vehicle speed, and the like thereof. Additionally, or alternatively, entity action parameters 132 may include a job quote 148. As used in this disclosure, a “action execution datum” is a price quote to job second entity for performing and completing entity action 128. Second entity disclosed here is described in further detail below. In a non-limiting example, action execution datum 148 within entity action parameters 132 may include an element of data describing a vehicle driver's hourly rate price. As non-limiting examples, action execution datum 148 within entity action parameters 132 may include an element of data describing a vehicle driver's rate in terms of price/load, price/mile, price/ton, price/cubic yard, price/ton/loaded mile, price/bushel, price/bushel/loaded mile, and/or the like.

With continued reference to FIG. 1, additionally, or alternatively, entity action 128 may include entity actions for a industries, such as, without limitation, agriculture, logging, forest products mills, dirt/grading/paving contractors/mining operations, heavy equipment transport, port industry, pine straw, nurseries, oil & natural gas, hazardous materials, and the like. In a non-limiting example, generating entity action 128 may include selecting at least one industry listed above. First entity that needs vehicle may select one or more of the above listed industries based on professional information within first entity profile 112. When processor 104 generates entity action 128, a customized list of truck types may be displayed based on the selection; for instance, without limitation, first entity who is a grading contractor may be able to select from dump trucks, not logging trucks when first entity is generating entity action 128. Entity action 128 may further be defined as a public entity action by first entity, wherein the public entity action may be issued to all of the trucking companies and/or vehicle drivers who own the specific truck type and who operate in a given service area as defined by the trucking company's/vehicle driver's business radius.

With continued reference to FIG. 1, processor 104 is configured to receive a second entity profile 152 associate to entity action 128 from a plurality of second entities. As used in this disclosure, an “second entity profile” is a data structure initialized by second entity containing information related to second entity. “Second entity,” as described herein, is an entity that is capable of performing entity action 128. In a non-limiting example, second entity may include such as, without limitations, vehicle driver, CDL driver, a group of vehicle drivers, truck company, and the like thereof. Second entity may not need to have formally applied to entity action 128. In a non-limiting example, first entity may receive a second entity profile 152 created and sent by second entity who is interested in entity action 128. In another non-limiting example, first entity may receive a plurality of suggested second entities, by processor 104, that is capable of performing entity action 128 posted by first entity. For instance, and without limitation, processor 104 may be configured to accept an input from second entity. Input may include second entity profile 152. Input may be accepted by processor 104 through smart assessment 120 described above. Second entity profile 152 may include a plurality of second entity related data. In some embodiments, second entity profile 152 may include a plurality of second entity related data 156, wherein plurality of second entity related data is information related to second entity, such as, without limitation, at least a second entity 160 described below. In a non-limiting example, second entity related data 156 within second entity profile 152 may include, without limitation, second entity's personal information (e.g., vehicle driver's name, age, gender, address, and the like), second entity's health information (e.g., vehicle driver's wellness, insurance, and the like), and second entity's professional information (e.g., vehicle registration information, vehicle driving experience, vehicle information, vehicle driver's entity action radius and the like). Receiving second entity profile 152 to entity action 128 may include receiving second entity profile 152 in a similar manner described above in this disclosure. In a non-limiting example, second entity may submit a second entity profile 152 to first entity through smart assessment 120 described above. Additionally, or alternatively, processor 104 may receive a plurality of second entity profiles 152 to entity action 128; for instance, entity action 128 may include a second entity queue, wherein the second entity queue may include a plurality of second entity profiles 152 sorted in chronological order (i.e., time of receiving second entity profile 152 in ascending order).

With continued reference to FIG. 1, processor 104 is configured to identify at least one second entity 160 as a function of second entity profile 152 and entity action 128. In some cases, identifying at least one second entity 160 may include identifying a plurality of second entities; for instance, without limitation, first entity may generate an entity action, wherein the entity action may require transporting 20 payloads. First entity may identify an initial second entity and a subsequent second entity, wherein the first second entity may take 10 of 20 payloads from the first entity, and the subsequent second entity may take the rest of the payloads. In some embodiments, identifying at least one second entity 160 may include receiving a customized action execution datum 148. In a non-limiting example, second entity (i.e., vehicle driver) may submit an action execution datum different than action execution datum 148 specified in entity action 128 generated by first entity. First entity may propose a counteroffer; for instance, negotiating the hourly rate of the entity action, changing the workload, selecting a different route, and the like thereof. Entity action parameters 132 such as, without limitation, route parameters 140, vehicle parameters 144, and the like may be modified as a function of the counteroffer.

With continued reference to FIG. 1, in some embodiments, at least one second entity 160 may be identified manually by first entity. In a non-limiting example, first entity may review all second entity profiles 152 within second entity queue and select at least one second entity profile, wherein the at least one second entity profile may include a second entity profile 152 corresponding at least one second entity 160 which first entity is satisfied. In a non-limiting example, processor 104 may scan all second entity profiles 152 within second entity queue, using language processing module described above in this disclosure. Scanning second entity profiles 152 may include extracting second entity related data 156, using language processing module described above. Extracted second entity related data 156 may be displayed through visual interface on user device of first entity. First entity may manually review displayed second entity related data 156. As used in this disclosure, a “second entity queue” is a data structure for storing one or more second entity profiles 152. In a non-limiting example, second entity queue is a collection of second entity profiles 152 that are maintained in a sequence and can be modified by the addition of new second entity profiles at one end of the sequence and removal of existed second entity profiles from the other end of the sequence; for instance, and without limitation, second entity queue may include a first-in-first-out (FIFO) data structure, wherein the FIFO data structure allows first entity and/or processor 104 to review second entity profiles 152 in an order such that second entity profile that have existed for a long period of time may be reviewed by first entity and/or processor 104 first. In other embodiments, second entity queue may be implemented in other data structures described in this disclosure, such as, without limitation, in a linked list. In another non-limiting example, receiving at least one second entity profile 152 associate with entity action 128 may include initializing, by processor 104, a second entity queue configured to store a plurality of second entity profiles 152. Receiving at least one second entity profile 152 may further include storing the at least one second entity profile 152 in second entity queue.

In some embodiments, identifying at least one second entity 160 may be semi-automated. In some embodiments, processor 104 may be configured to simplify the process of identifying at least one second entity 160. In a non-limiting example, plurality of second entities within second entity queue may be sorted using sorting algorithms such as, without limitation, one or more sorting algorithms described above, in descending order according to an applicant rating specified in second entity profile 152. As used in this disclosure, an “applicant rating” is a classification or ranking of the corresponding second entity (i.e., vehicle driver) rated by a plurality of previous first entities second entity worked for based on historical entity actions, wherein the historical entity actions are entity actions prior to entity action 128. In some cases, applicant rating may include a rating score from a first rating score x to a second rating score y; for instance, applicant rating may include a rating score from 0 to 5, wherein the rating score close to 0 indicate a low applicant rating and rating score close to 5 indicate a high applicant rating. Low applicant rating may indicate corresponding second entity is not capable of performing entity action 128, while high applicant rating may indicate corresponding second entity is capable of performing entity action 128 well. First entity may select at least one second entity with high applicant rating (or rating score) from beginning portion of second entity queue. In other cases, second entities within second entity queue may be sorted in ascending order based on geographical distance between first entity and second entity. First entity may select at least one second entity that is nearest to first entity. Similarly, first entity may include a first entity rating, wherein the first entity rating is a classification or ranking of first entity based on historical entity actions, rated by plurality of a plurality of previous second entities hired by first entity in similar manner described above.

With continued reference to FIG. 1, additionally, or alternatively, process of identifying at least one second entity 160 may be fully automated. In a non-limiting example, identifying at least one second entity 160 may include matching, by processor 104, at least one second entity to entity action 128. In some embodiments, processor 104 may be configured to search second entity queue for at least one second entity 160 using one or more searching algorithms, such as, without limitation, linear search, binary search, and the like based on similarity between entity action parameters 132 and second entity profile 152. Continuing the example, processor 104 may be configured to pair each second entity profile 152 of each second entity within second entity queue to entity action 128 and calculate a similarity between the vehicle parameters 144 and second entity related data 156 within second entity profile 152. Similarity may be calculated using distance functions, such as, without limitation L2 norm, Euclidean distance, squared Euclidean distance, Canberra distance, Chebyshev distance, Minkowski distance, Cosine distance, Pearson correlation distance, spearman correlation, Mahala Nobis distance, standardized Euclidean distance, Chi-square distance, Jensen-Shannon distance, Levenshtein distance, Dice distance, and the like thereof. Processor 104 may be further configured to select a pair of second entity profile 152 and entity action 128 with maximum similarity (or otherwise minimum dissimilarity) and match corresponding vehicle driver (i.e., second entity) to entity action 128.

With continued reference to FIG. 1, in some embodiments, at least one second entity 160 may be identified using a machine-learning process 164. A “machine-learning process,” as used in this disclosure, is a process that automatedly uses a body of data known as “training data” and/or a “training set” (described further below in this disclosure) to generate an algorithm that will be performed by a processor 104/module to produce outputs given data provided as inputs; this is in contrast to a non-machine learning software program where the commands to be executed are determined in advance by a user and written in a programming language. Machine-learning process may utilize supervised, unsupervised, lazy-learning processes and/or neural networks, described further below. In some embodiments, machine-learning process 164 may include processor 104 generate a second entity machine-learning model, wherein generating the second entity machine-learning model may include training second entity machine-learning model using second entity training data, and wherein the second entity training data may include a plurality of entity actions correlated to a plurality of second entities. Plurality of second entities may include a plurality of most suitable second entities for plurality of entity actions 128; for instance, for a given entity action, a most suitable second entity may include a most suitable vehicle driver profile, wherein the most suitable vehicle driver profile may include one or more second entity related data indicating such as, without limitation, nearest second entity within first entity's business radius, highest applicant rating, expected vehicle, and the like thereof. Second entity training data may come from data store 168 described in further detail below, such as any database described in this disclosure, or be provided by first entity. In some embodiments, machine-learning process 164 may obtain second entity training data for generating second entity machine-learning model by querying a communicatively connected data store 168 that includes past inputs and outputs; for instance, without limitation, second entity training data may include a plurality of previous entity actions posted by first entities as input correlated to a plurality of previous identified second entities as output. In some embodiments, correlations may indicate causative and/or predictive links between data, which may be modeled as relationships, such as mathematical relationships, by machine-learning models, as described in further detail below. In a non-limiting example, processor 104 may identify a most suitable second entity for a given entity action 128 through second entity machine-learning model using machine-learning process 164. Processor 104 may then identify at least one second entity 160 within second entity queue as a function of the most suitable second entity; for instance, processor 104 may select at least one second entity 160 within second entity queue with a maximum similarity (or otherwise minimum dissimilarity) to the most suitable second entity identified by machine-learning process 164. Similarity may be calculated by comparing using one or more distance functions described above.

With continued reference to FIG. 1, in a non-limiting example, processor 104 may be configured to identify at least one second entity 160 based on entity activity 128 generated by processor 104 using first entity profile 112, particularly, entity action parameters 132; for instance, and without limitation, processor 104 may identity at least one second entity 160 based on a corresponding second entity profile 152 within second entity queue, wherein the corresponding second entity profile 152 may include second entity related data containing vehicle information that match the entity action parameters 132, particularly vehicle parameters 144. Match may be determined as a function of similarity calculated through distance functions described above in this disclosure. Additionally, or alternatively, processor 104 may be configured to identity an initial second entity that include vehicle information specifying a vehicle that is only satisfy partial entity action parameters 132; for instance, and without limitation, the vehicle may only include a payload volume that is capable for transporting partial loads specified in entity action parameters 132 of entity action 128. Processor 104 may be configured to subsequently identity a subsequent second entity that include vehicle information specifying another vehicle that satisfy the rest entity action parameters 132; for instance, and without limitation, the another vehicle may include a payload volume that is capable for transporting the rest of loads specified in entity action parameters 132 of entity action 128.

With continued reference to FIG. 1, first entity profile 112, second entity profile 152, and any data described in this disclosure may be received and/or stored in a data store 168 such as, without a limitation, a database. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

With continued reference to FIG. 1, apparatus 100 may include a cloud environment. As used in this disclosure, a “cloud environment” is a set of systems and/or processes acting together to provide services in a manner that is dissociated with underlaying hardware and/or software within apparatus 100 used for such purpose and includes a cloud. A “cloud,” as described herein, refers to one or more devices (i.e., servers) that are accessed over the internet. In some cases, cloud may include Hybrid Cloud, Private Cloud, Public Cloud, Community Cloud, any cloud defined by National Institute of Standards and Technology (NIST), and the like thereof. In some embodiments, cloud may be remote to apparatus 100; for instance, cloud may include a plurality of functions distributed over multiple locations external to apparatus 100. Location may be a data center. In a non-limiting example, data store 168 may run on one or more cloud servers. Data such as, without limitation, first entity profile 112, second entity profile 152, and the like stored in data store 168 may not be found in local storage of apparatus 100. In some embodiments, cloud environment may include implementation of cloud computing. As used in this disclosure, “cloud computing” is an on-demand delivery of information technology (IT) resources within a network through internet, without direct active management by either first entity or second entity. In some embodiment, without limitation, cloud computing may include a Software-as-a-Service (SaaS). As used in this disclosure, a “Software-as-a-Service” is a cloud computing service model which make software available to first entity, vehicle driver, and/or any other user using apparatus 100 directly; for instance, SaaS platform may provide partial or entire set of functionalities of apparatus 100 to first entity without direct installation of the entire set of functionalities. In a non-limiting example, data store 168 may be disposed in a SaaS platform. Receiving data such as, without limitation, first entity profile 112, second entity profile 152 and the like may include storing data listed above in SaaS platform such as, without limitation, MICROSOFT 365, SALESFORCE, DROPBOX, G SUITE, and the like thereof. In some embodiments, data store 168 may be configured to backup stored data such as, without limitation, first entity profile 112, second entity profile 152, and the like through cloud-to-cloud backup. Continuing the example, SaaS platform may be configured to create a plurality of copies of stored data listed above and storing the plurality of copies in another public cloud such as, without limitation, AWS.

With continued reference to FIG. 1, processor 104 is configured to generate a completion datum 172 as a function of entity action 128 and the at least one second entity. As used in this disclosure, a “completion datum” is a data element representing a completion of entity action 128. In some cases, completion datum 172 may include data regarding completion of entity action 128 such as, without limitation, arrival time, total hours, travel distance, route of travel, and the like thereof. In some embodiments, completion of entity action 128 may be defined as satisfying one or more entity action parameters 132 specified within entity action 128. In a non-limiting example, completion of entity action 128 may include delivering a target cargo (i.e., first entity action parameter) to a target destination (i.e., second entity action parameter) specified in entity action 128. In some embodiments, generating completion datum 172 may include checking the at least one second entity. As used in this disclosure, “checking” means examining, inspecting, or otherwise checking on second entity regarding to entity action 128. In a non-limiting example, checking second entity may include performing one or more check-ins on the path from a first location to a second location; for instance, and without limitation, the first location may be a first state and the second location may be a second state. As used in this disclosure, a “check-in” is a process of updating an entity action status by first entity and/or second entity. For example, without limitation, second entity may update status such as, without limitation, vehicle driver's status, traffic status, payload status, and or the like at a check point. Second entity (i.e., vehicle driver) may manually check in at specific check points specified by entity action parameters, particularly route parameters in entity action 128. In some embodiments, check-ins may be automatically performed by processor 104 when second entity physically arrived at check point indicated by navigation API such as, without limitation, GOOGLE MAP application programing interfaces (APIs). In a non-limiting example, processor 104 may be configured to call APIs for location retrieval. Processor 104 may be further configured to convert a location retrieved through the APIS for location retrieval into a coordinate using Geocoding APIs, compare the coordinate to the check point coordinate, and calculate a coordinate difference, wherein the coordinate difference is an evaluation of the distance between converted coordinate and the check point coordinate. At least one second entity 160 may be checked if calculated coordinate difference resides in a pre-defined range. Additionally, or alternatively, check-ins may allow deviation of route within a predetermined deviation threshold. As used in this disclosure, a “deviation threshold” is a magnitude that second entity cannot exceeded for completion of entity action 128. In a non-limiting example, second entity 160 may be allowed to detour within a predetermined radius from current location. Further, completion datum 172 may be generated at or after each check-ins. In a non-limiting example, check-ins may be automatically performed when second entity's (i.e., vehicle driver's) location changed from a first geofence to a second geofence. As used in this disclosure, a “geofence” is a virtual perimeter for a real-word geographic area. In some cases, geofence may be dynamically generated/determined as in a radius around a point location, or match a predefined set of boundaries such as, without limitation, school zones, business zones, factory zones, neighborhood boundaries, and the like thereof. At least one completion datum 172 may be generated when second entity exits first geofence and enter second geofence. In this case, check point may be the junction of two geofences.

With continued reference to FIG. 1, in some embodiments, second entity may use a location-aware user device such as, without limitation, a laptop, smart phone, and the like with location-based service. Exiting and/or entering a geofence may include triggering an alert to user device of second entity and/or first entity. In a non-limiting example, first entity may receive a signal when second entity exits first geofence and enter second geofence. As used in this disclosure, a “signal” is any intelligible representation of data, for example from one device to another. A signal may include an optical signal, a hydraulic signal, a pneumatic signal, a mechanical signal, an electric signal, a digital signal, an analog signal and the like. In some cases, a signal may be used to communicate with a computing device, for example by way of one or more ports. In some cases, a signal may be transmitted and/or received by a computing device, for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like. In another non-limiting example, first entity and second entity may both receive a message such as, a text message, email, notification, and/or the like when second entity exits first geofence and enter second geofence.

With continued reference to FIG. 1, in some cases, apparatus 100 may perform one or more signal processing steps on a signal. For instance, apparatus 100 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which vary continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, in some embodiments, generating completion datum 172 may include accepting a completion token from at least one second entity. As used in this disclosure, a “completion token” is a data submission 124 that proves the completion of entity action 128. In some embodiments, completion token may include physical ticket such as, without limitation, printed document, souvenir, and the like thereof. In other embodiments, completion token may include electronic ticket such as, without limitation, electronic document, email, message, and the like thereof. In a non-limiting example, completion token may include a printed scale ticket at a mill, picture at destination, timecard during the trip, and the like thereof. Completion token may be accepted through smart assessment 120 described above in this disclosure. Additionally, or alternatively, generating the completion datum 172 may include submitting action execution datum 148 to at least one second entity as a function of the completion datum 172. Action execution datum may be any action execution datum described in this disclosure. In some embodiments, action execution datum 148 and/or completion datum 172 may include a payment such as, without limitation, a one-time payment. In a non-limiting example, completion datum 172 may include a total hour of entity action 128, first entity may submit payment at least one second entity at the end of entity action 128 as a function of the total hour of the entity action and the hourly rate specified by action execution datum 148 within entity action parameters 132 of entity action 128. In other embodiments, action execution datum 148 may include a plurality of sub-payments, wherein each sub-payment is a portion of a payment. In a non-limiting example, first entity may submit a sub payment at least one second entity after each check-ins described above. Additionally, or alternatively, action execution datum 148 may include an additional payment such as, without limitation, highway use fee (HUF), medical bills (for medical treatment and/or medication arising from the performance of entity action 128), maintenance fee, and the like thereof. In other embodiments, action execution datum 148 may include a deduct payment; for instance, action execution datum may be lower than action execution datum 148 specified in entity action parameters 132 if at least one second entity does not complete entity action 128 as expected (e.g., damaging payloads in transit, not completing on time, incorrect routing, and the like thereof). Further, action execution datum 148 may be submitted through financial services and/or software such as, without limitation, STRIPE, and the like thereof.

With continued reference to FIG. 1, in some embodiments, submitting action execution datum 148 to at least one second entity may include verifying completion datum 172. In some embodiments, verifying completion datum 172 may include verifying completion datum 172 by first entity. In a non-limiting example, first entity may review entity action parameters 132 and each check-ins performed by at least one second entity. First entity may submit a payment once first entity is satisfied upon the manual verification. In other embodiments, verifying completion datum 172 be verified by processor 104. As used in this disclosure, “verification” is a process of ensuring that which is being “verified” complies with certain constraints, for example without limitation system requirements, regulations, and the like. In some cases, verification may include comparing a product, such as, without limitation, completion datum 172 against one or more acceptance criteria. For example, in some cases, completion datum 172 may be required to go through all checkpoints and complete corresponding check-ins and/or include a number of different types of completion token described above. Ensuring that completion datum 172 is in compliance with acceptance criteria may, in some cases, constitute verification. In some cases, verification may include ensuring that data is complete, for example that all required data types are present, readable, uncorrupted, and/or otherwise useful for processor 104. In some cases, some or all verification processes may be performed by processor 104. In some cases, at least a machine-learning process, for example a machine-learning model, may be used to verify. Processor 104 may use any machine-learning process described in this disclosure for this or any other function. In some embodiments, at least one of validation and/or verification includes without limitation one or more of supervisory validation, machine-learning processes, graph-based validation, geometry-based validation, and rules-based validation.

With continued reference to FIG. 1, as used in this disclosure, “validation” is a process of ensuring that which is being “validated” complies with stakeholder expectations and/or desires. Stakeholders may include users, administrators, property owners, customers, and the like. In a non-limiting example, stakeholder may include first entity. Very often a specification prescribes certain testable conditions (e.g., metrics) that codify relevant stakeholder expectations and/or desires. In some cases, validation includes comparing a product, for example without limitation, completion datum 172, against a specification. In some cases, processor 104 may be additionally configured to validate a product by validating constituent sub-products. In some embodiments, processor 104 may be configured to validate any product or data, for example without limitation, completion datum 172. In some cases, at least a machine-learning process, for example a machine-learning model, may be used to validate by processor 104. Processor 104 may use any machine-learning process described in this disclosure for this or any other function. In some embodiments, verifying completion datum 172 may include verifying number of check-ins performed by at least one second entity 160. Check-ins may be performed using processing steps described above in this disclosure. In some embodiments, verifying completion datum 172 may include verifying completion token accepted by processor 104 from at least one second entity 160. Completion token may include any completion token described in this disclosure.

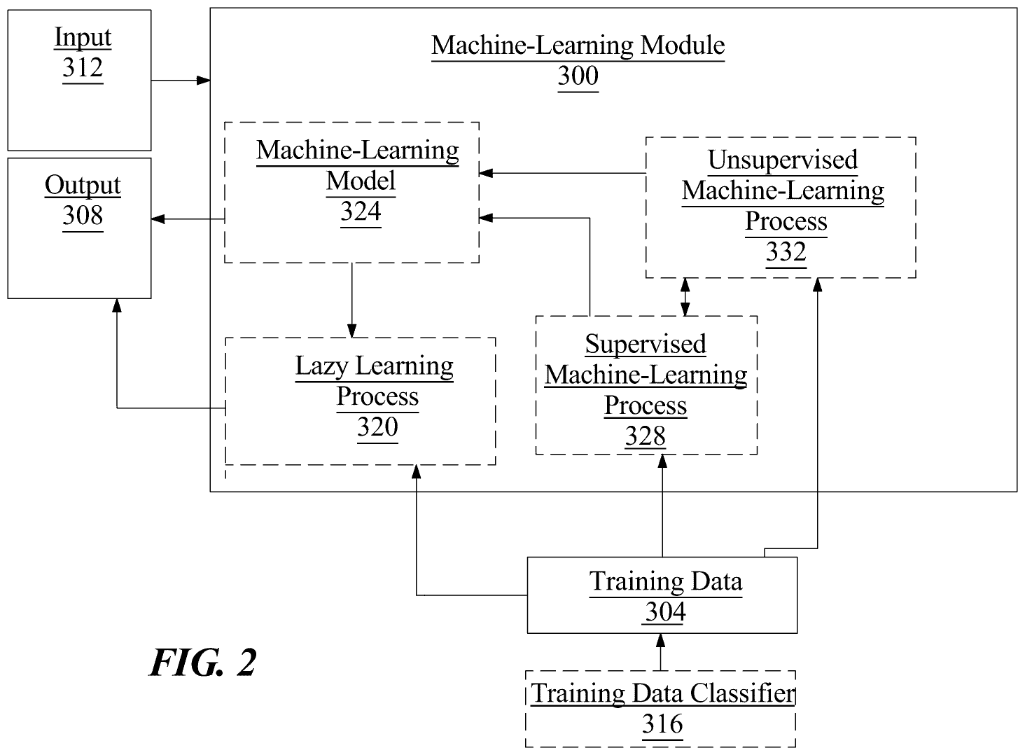

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example inputs such as entity actions and outputs such as second entities.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to second entity types, based on, as non-limiting examples, cost, vehicles, timeframe, availability, and the like.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include entity actions as described above as inputs, second entities as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

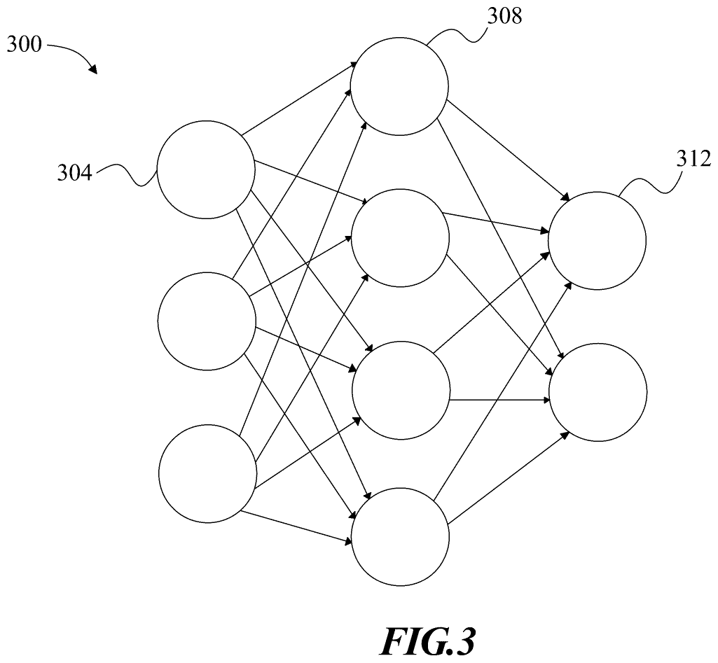

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

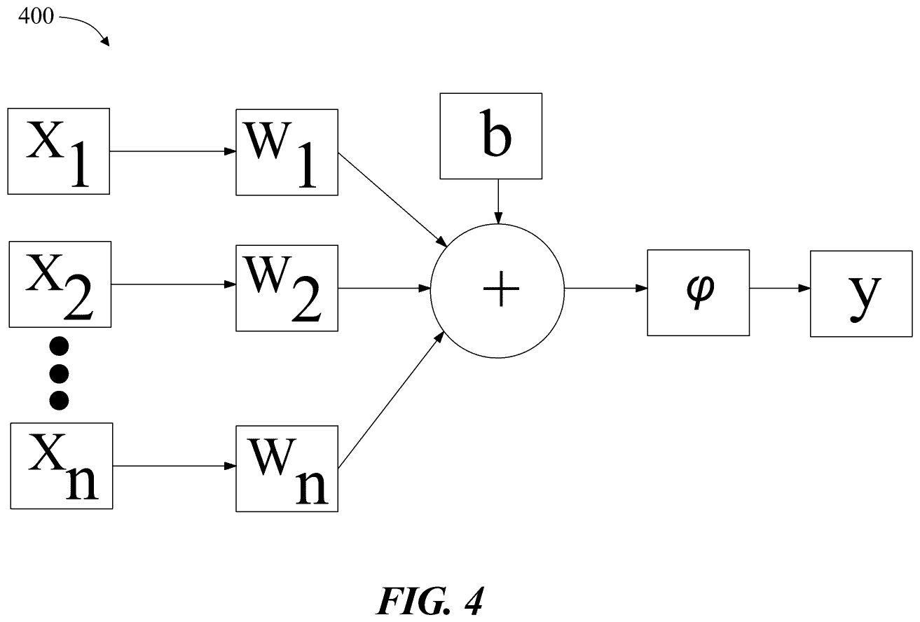

Referring now to FIG. 4, an exemplary embodiment of a node of a neural network is illustrated. A node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above.

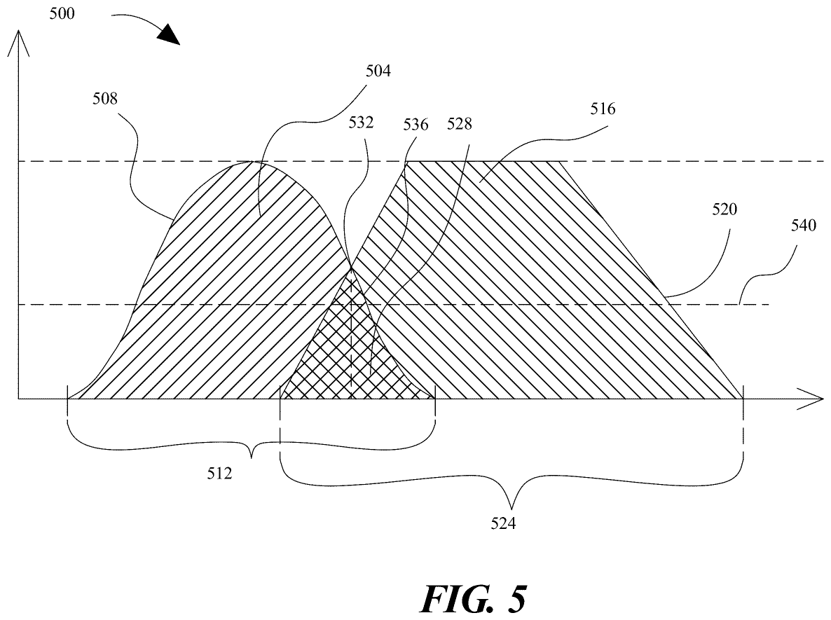

Referring to FIG. 5, an exemplary embodiment of fuzzy set comparison 500 is illustrated. A first fuzzy set 504 may be represented, without limitation, according to a first membership function 508 representing a probability that an input falling on a first range of values 512 is a member of the first fuzzy set 504, where the first membership function 508 has values on a range of probabilities such as without limitation the interval [0,1], and an area beneath the first membership function 508 may represent a set of values within first fuzzy set 504. Although first range of values 512 is illustrated for clarity in this exemplary depiction as a range on a single number line or axis, first range of values 512 may be defined on two or more dimensions, representing, for instance, a Cartesian product between a plurality of ranges, curves, axes, spaces, dimensions, or the like. First membership function 508 may include any suitable function mapping first range 512 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 5, first fuzzy set 504 may represent any value or combination of values as described above, including output from one or more machine-learning models and a predetermined class. A second fuzzy set 516, which may represent any value which may be represented by first fuzzy set 504, may be defined by a second membership function 520 on a second range 524; second range 524 may be identical and/or overlap with first range 512 and/or may be combined with first range via Cartesian product or the like to generate a mapping permitting evaluation overlap of first fuzzy set 504 and second fuzzy set 516. Where first fuzzy set 504 and second fuzzy set 516 have a region 528 that overlaps, first membership function 508 and second membership function 520 may intersect at a point 532 representing a probability, as defined on probability interval, of a match between first fuzzy set 504 and second fuzzy set 516. Alternatively, or additionally, a single value of first and/or second fuzzy set may be located at a locus 536 on first range 512 and/or second range 524, where a probability of membership may be taken by evaluation of first membership function 508 and/or second membership function 520 at that range point. A probability at 528 and/or 532 may be compared to a threshold 540 to determine whether a positive match is indicated. Threshold 540 may, in a non-limiting example, represent a degree of match between first fuzzy set 504 and second fuzzy set 516, and/or single values therein with each other or with either set, which is sufficient for purposes of the matching process; for instance, threshold may indicate a sufficient degree of overlap between an output from one or more machine-learning models and/or entity action and a predetermined class, such as without limitation second entity categorization, for combination to occur as described above. Alternatively, or additionally, each threshold may be tuned by a machine-learning and/or statistical process, for instance and without limitation as described in further detail below.

Further referring to FIG. 5, in an embodiment, a degree of match between fuzzy sets may be used to classify an entity action with second entity. For instance, if a second entity has a fuzzy set matching entity action fuzzy set by having a degree of overlap exceeding a threshold, processor 104 may classify the entity action as belonging to the second entity categorization. Where multiple fuzzy matches are performed, degrees of match for each respective fuzzy set may be computed and aggregated through, for instance, addition, averaging, or the like, to determine an overall degree of match.

Still referring to FIG. 5, in an embodiment, an entity action may be compared to multiple second entity categorization fuzzy sets. For instance, entity action may be represented by a fuzzy set that is compared to each of the multiple second entity categorization fuzzy sets; and a degree of overlap exceeding a threshold between the entity action fuzzy set and any of the multiple second entity categorization fuzzy sets may cause processor 104 to classify the entity action as belonging to second entity categorization. For instance, in one embodiment there may be two second entity categorization fuzzy sets, representing respectively second entity categorization and a second entity categorization. Initial second entity categorization may have a first fuzzy set; Subsequent second entity categorization may have a second fuzzy set; and entity action may have a entity action fuzzy set. processor 104, for example, may compare a entity action fuzzy set with each of second entity categorization fuzzy set and in second entity categorization fuzzy set, as described above, and classify a entity action to either, both, or neither of second entity categorization nor in second entity categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, entity action may be used indirectly to determine a fuzzy set, as entity action fuzzy set may be derived from outputs of one or more machine-learning models that take the entity action directly or indirectly as inputs.

Still referring to FIG. 5, a computing device may use a logic comparison program, such as, but not limited to, a fuzzy logic model to determine a second entity response. An second entity response may include, but is not limited to, second entity with highest applicant rating, second entity with nearest distance, second entity with highest number of entity action completed, and the like thereof; each such second entity response may be represented as a value for a linguistic variable representing second entity response or in other words a fuzzy set as described above that corresponds to a degree of match of second entity as calculated using any statistical, machine-learning, or other method that may occur to a person skilled in the art upon reviewing the entirety of this disclosure. In other words, a given element of entity action may have a first non-zero value for membership in a first linguistic variable value and a second non-zero value for membership in a second linguistic variable value. In some embodiments, determining a second entity categorization may include using a linear regression model. A linear regression model may include a machine learning model. A linear regression model may be configured to map data of entity action, such as degree of match to one or more second entity parameters. A linear regression model may be trained using a machine learning process. A linear regression model may map statistics such as, but not limited to, quality of entity action. In some embodiments, determining a second entity of entity action may include using a second entity classification model. A second entity classification model may be configured to input collected data and cluster data to a centroid based on, but not limited to, frequency of appearance, linguistic indicators of quality, and the like. Centroids may include scores assigned to them such that quality of entity action may each be assigned a score. In some embodiments second entity classification model may include a K-means clustering model. In some embodiments, second entity classification model may include a particle swarm optimization model. In some embodiments, determining the second entity of a entity action may include using a fuzzy inference engine. A fuzzy inference engine may be configured to map one or more entity action data elements using fuzzy logic. In some embodiments, entity action may be arranged by a logic comparison program into second entity arrangement. A “second entity arrangement” as used in this disclosure is any grouping of objects and/or data based on skill level and/or output score. This step may be implemented as described above in FIGS. 1-4. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 5, an inference engine may be implemented according to input and/or output membership functions and/or linguistic variables. For instance, a first linguistic variable may represent a first measurable value pertaining to entity action, such as a degree of match of an element, while a second membership function may indicate a degree of in second entity of a subject thereof, or another measurable value pertaining to entity action. Continuing the example, an output linguistic variable may represent, without limitation, a score value. An inference engine may combine rules, such as: “if the rating score of a second entity is ‘high’ and the distance to first entity is ‘close’, the second entity is ‘suitable’”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b-a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

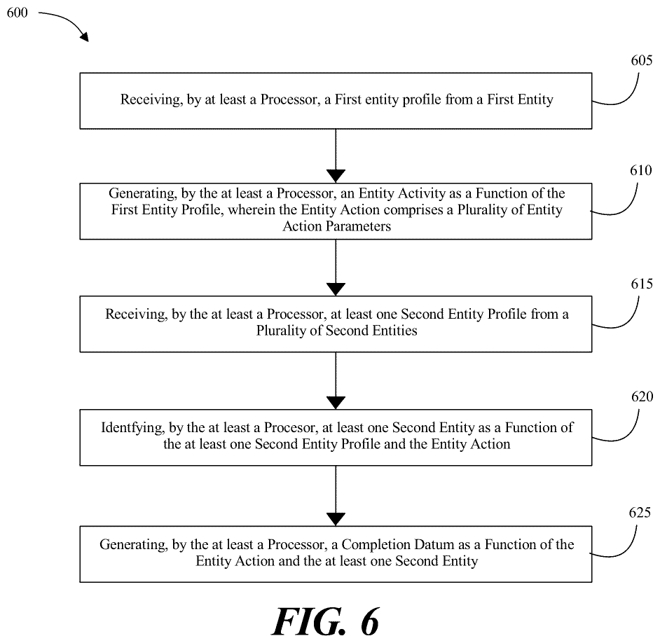

Now referring to FIG. 6, an exemplary method 600 for completing an entity action using a computing device is illustrated. Method 600 includes a step 605 of receiving, by at least a processor, a first entity profile from a first entity, without limitation, as described above in reference to FIGS. 1-5. In some embodiments, step 605 of receiving the first entity profile may include accepting a smart assessment containing a data submission from the first entity. This may be implemented, without limitation, as described above in reference to FIGS. 1-5.

With continued reference to FIG. 6, method 600 includes a step 610 of generating, by the at least a processor, an entity action as a function of the first entity profile, wherein the entity action includes a plurality of entity action parameters. This may be implemented, without limitation, as described above in reference to FIGS. 1-5. In some embodiments, step 610 of generating the entity action may include selecting an action category, wherein the action category may include an entity action chosen from the group consisting of a public entity action, a private entity action, and a dispatch entity action. In some embodiments, the plurality of entity action parameters may include a plurality of route parameters, a plurality of vehicle parameters, and an action execution datum. This may be implemented, without limitation, as described above in reference to FIGS. 1-5.

With continued reference to FIG. 6, method 600 includes a step 615 of receiving, by the at least a processor, at least one second entity profile associated with the entity action from a plurality of second entities. This may be implemented, without limitation, as described above in reference to FIGS. 1-5.

With continued reference to FIG. 6, method 600 includes a step 620 of identifying, by the at least a processor, at least one second entity as a function of the at least one second entity profile and the entity action, without limitation, as described above in reference to FIGS. 1-5. In some embodiments, step 615 of identifying the at least one second entity may include receiving a customized action execution datum. In some embodiments, step 615 of identifying the at least one second entity may include identifying the at least one second entity associated with the entity action using a machine learning process trained using second entity training data, wherein the second entity training data may include a plurality of entity actions as input correlated to a plurality of second entities as output. This may be implemented, without limitation, as described above in reference to FIGS. 1-5.

With continued reference to FIG. 6, method 600 includes a step 625 of generating, by the at least a processor, a completion datum as a function of the entity action and the at least one second entity, without limitation, as described above in reference to FIGS. 1-5. In some embodiments, step 625 of generating the completion datum may include receiving at least a check-in datum from the at least one second entity. In some embodiments, receiving the at least a check-in datum may include performing a plurality of check-ins from a first location to a second location. In some embodiments, receiving the at least a check-in datum may include accepting a completion token from the at least one second entity. In some embodiments, step 625 of generating the completion datum may include submitting the action execution datum to the at least one second entity as a function of the completion datum. This may be implemented, without limitation, as described above in reference to FIGS. 1-5.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

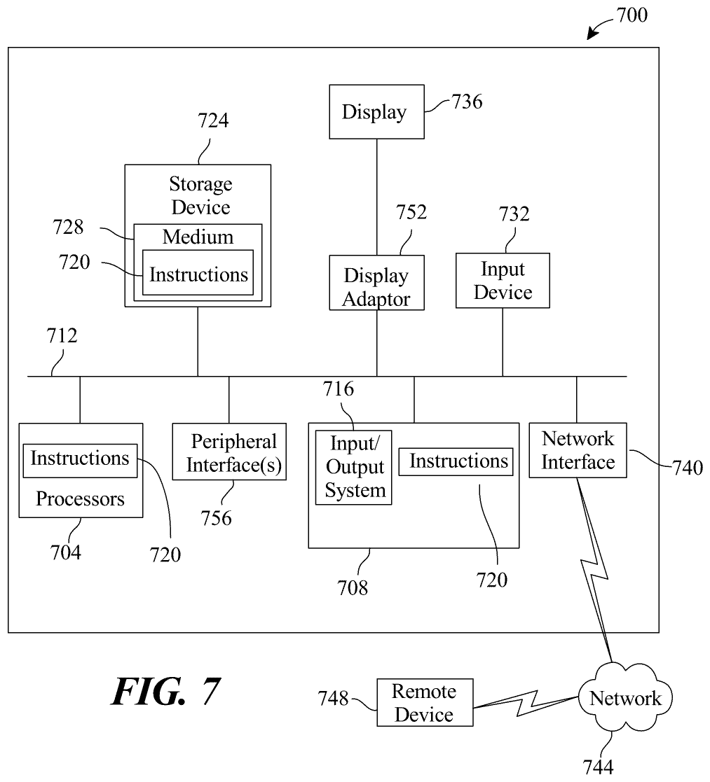

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for completing entity action using a computing device, the apparatus comprises:
at least a processor; and
a memory communicatively connected to the at least a processor containing instructions configuring the at least a processor to:
receive a first entity profile from a first entity;
generate an entity action as a function of the first entity profile, wherein the entity action comprises a plurality of entity action parameters and wherein one or more fees are associated with the entity action;
determine a plurality of second entities associated with the entity action, wherein the plurality of second entities are arranged based on geographical distance between the first entity and a second entity from the plurality of second entities;
iteratively train a fee machine learning model configured to associate fees with entity types, wherein training the fee machine learning model is performed iteratively by a lazy learning process selecting an arranged second entity of the plurality of second entities;
receive at least one second entity profile associated with the entity action from the fee machine learning model;
identify at least one second entity as a function of the at least one second entity profile and the entity action; and
generate a completion datum as a function of the entity action and the received at least one second entity profile, wherein generating the completion datum comprises generating a deviation threshold for completing the entity action.

2. The apparatus of claim 1, wherein the receiving the first entity profile comprises accepting a smart assessment containing a data submission from the first entity.

3. The apparatus of claim 1, wherein inputting the entity action comprises selecting an action category, wherein the action category comprises an entity action chosen from the group consisting of a public entity action, a private entity action, and a dispatch entity action.

4. The apparatus of claim 1, wherein the plurality of entity action parameters comprises:
a plurality of route parameters, a plurality of vehicle parameters, and an action execution datum.

5. The apparatus of claim 1, wherein generating the entity action comprises generating an entity action code.

6. The apparatus of claim 1, wherein identifying the at least one second entity comprises:
identifying the at least one second entity associated with the entity action using a machine learning process trained using second entity training data, wherein the second entity training data comprises a plurality of entity actions as input correlated to a plurality of second entities as output.

7. The apparatus of claim 1, wherein generating the completion datum comprises receiving at least a check-in datum from the at least one second entity, wherein the check-in datum comprises a check point coordinate.

8. The apparatus of claim 7, wherein receiving the at least a check-in datum comprises performing a plurality of check-ins from a first location to a second location.

9. (canceled)

10. The apparatus of claim 4, wherein generating the completion datum comprises submitting the action execution datum to the at least one second entity as a function of the completion datum.

11. A method for completing entity action using a computing device, the method comprises:
receiving, by at least a processor, a first entity profile from a first entity;
generating, by the at least a processor, an entity action as a function of the first entity profile, wherein the entity action comprises a plurality of entity action parameters and wherein one or more fees are associated with the entity action;
determining, by the at least a processor, a plurality of second entities associated with the entity action, wherein the plurality of second entities are arranged based on geographical distance between the first entity and a second entity from the plurality of second entities;
iteratively training, by the at least a processor, a fee machine learning model configured to associate fees with entity types, wherein training the fee machine learning model is performed iteratively by a lazy learning process selecting an arranged second entity of the plurality of second entities;
receiving at least one second entity profile associated with the entity action from the fee machine learning model;
identifying, by the at least a processor, at least one second entity as a function of the at least one second entity profile and the entity action; and
generating, by the at least a processor, a completion datum as a function of the entity action and the received at least one second entity profile, wherein generating the completion datum comprises generating a deviation threshold for completing the entity action.

12. The method of claim 11, wherein the receiving the first entity profile comprises accepting a smart assessment containing a data submission from the first entity.

13. The method of claim 11, wherein inputting the entity action comprises selecting an action category, wherein the action category comprises an entity action chosen from the group consisting of a public entity action, a private entity action, and a dispatch entity action.

14. The method of claim 11, wherein the plurality of entity action parameters comprises:
a plurality of route parameters, a plurality of vehicle parameters, and an action execution datum.

15. The method of claim 1, wherein generating the entity action comprises generating an entity action code.

16. The method of claim 11, wherein identifying the at least one second entity comprises:
identifying the at least one second entity associated with the entity action using a machine learning process trained using second entity training data, wherein the second entity training data comprises a plurality of entity actions as input correlated to a plurality of second entities as output.

17. The method of claim 11, wherein generating the completion datum comprises receiving at least a check-in datum from the at least one second entity, wherein the check-in datum comprises a check point coordinate.

18. The method of claim 17, wherein receiving the at least a check-in datum comprises performing a plurality of check-ins from a first location to a second location.

19. (canceled)

20. The method of claim 14, wherein generating the completion datum comprises submitting the action execution datum to the at least one second entity as a function of the completion datum.

21. The apparatus of claim 7, wherein generating the completion datum further comprises:
receiving a coordinate of the at least one second entity;
calculating a difference between the check point coordinate and the coordinate of the at least one second entity; and
comparing the difference to the deviation threshold.

22. The method of claim 17, wherein generating the completion datum further comprises:
receiving a coordinate of the at least one second entity;
calculating a difference between the check point coordinate and the coordinate of the at least one second entity; and
comparing the difference to the deviation threshold.
